(19) United States
(12) Patent Application Publication
(10) Pub. No.: US 2006/0197755 A1
(43) Pub. Date: Sep. 7, 2006

(54) Computer stylus cable system and method

(76) Inventor: Muhammad Ali Bawany, Sachse, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/070,608

(22) Filed: Mar. 2, 2005

(51) Int. Cl. G09G 5/00

(52) U.S. Cl. 345/179

(57) ABSTRACT

Disclosed is a cable assembly having a connector for coupling to at least one of a stylus and a display assembly, the cable assembly having at least one conductor for providing charging power to a rechargeable power supply of the stylus from a power supply of the display assembly.

### DESCRIPTION OF RELATED ART

Computer systems have advanced significantly in recent years to provide an improved and more natural user experience. For example, graphical user interfaces have been developed which present a representation of a more natural work environment to a user facilitating intuitive interaction with the computer. Input devices have been developed which enable a user to easily input data, select functions, etcetera. Computer systems providing an input/output interactive surface responsive to a stylus have been developed to provide a user experience approaching that of putting pen to paper, although providing much more functionality and enhanced features. For example, tablet computer systems (referred to herein as tablet PCs), such as the TC 1000 Tablet PC available from Hewlett-Packard Company, provide a display and stylus enabling a user to input data by pointing and/or moving the stylus across the display.

However, the provision of advancements in user experience has not been without challenge. For example, in order for the user's experience to approach that of putting pen to paper, the display of a typical tablet PC will not only come into contact with the aforementioned stylus, but will also come into contact with portions of the user's hand and/or fingers. For example, a side of the user's hand may rest against the display while manipulating the stylus to input data. Accordingly, the display used by many tablet PC configurations is not a touch screen configuration, but rather is of a configuration which responds to an active stylus to avoid erroneously responding to contact from a user's hand.

Such an active stylus comprises electronic circuitry for outputting telemetry signals, such as in the form of ultrasonic or radio frequency signals, for use by display circuitry in locating the position of the stylus. Accordingly, a typical stylus includes a replaceable battery to power the aforementioned electronic circuitry. When this battery becomes discharged, the battery must be replaced for further computing using the stylus. Moreover, because the display is adapted to respond to the stylus in order to avoid erroneously responding to contact from the user's hand, when the stylus' battery is discharged (little or no power remaining in the battery) further computing without the stylus is difficult, if not impossible.

The foregoing challenges associated with the use of an active stylus tablet PC configuration are further compounded by the fact that the stylus is generally a relatively small separate component which may easily be misplaced or lost. Attempts have been made to tether the stylus to the display, such as through the use of a lanyard. However, the use of such a tether has heretofore not been widely adopted.

### BRIEF DESCRIPTION OF THE DRAWINGS

FIG. 1A shows a block diagram of one embodiment of a tablet PC system according to the invention;

FIG. 1B shows a cut-away view of a portion of an embodiment of the cable assembly of FIG. 1B according to the invention;

FIG. 2 shows a block diagram of another embodiment of a tablet PC system according to the invention; and

FIG. 3 shows a flow diagram of operation according to embodiments.

### DETAILED DESCRIPTION

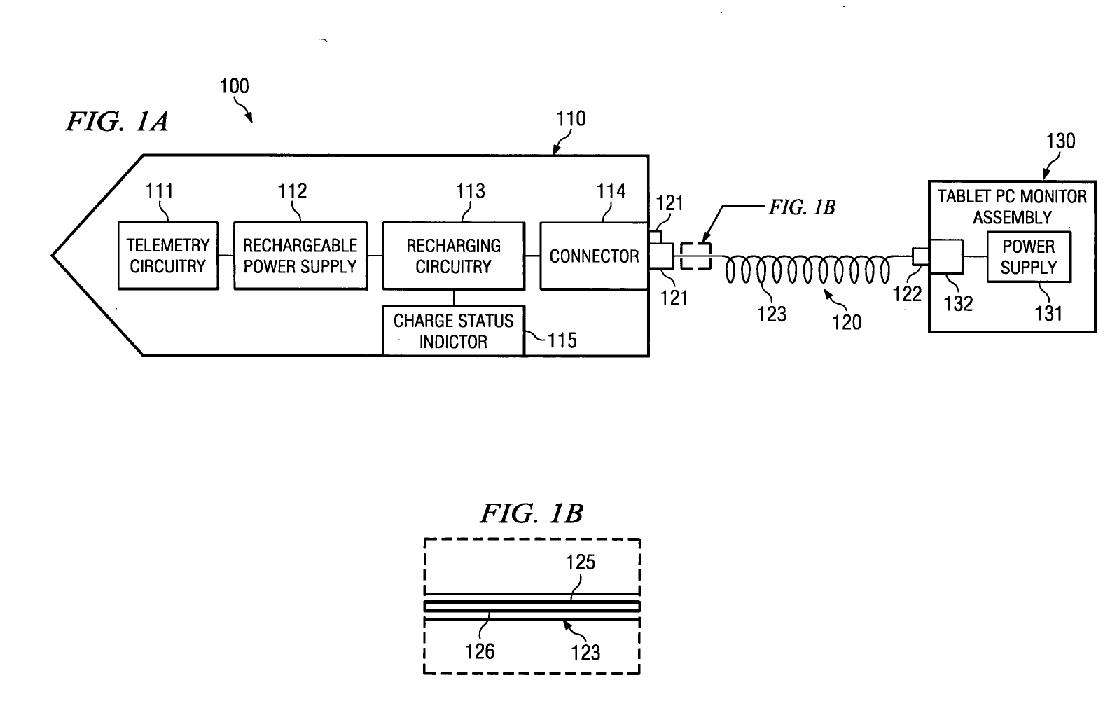

FIG. 1A shows tablet PC system 100 adapted according to one embodiment. Stylus 110 of the illustrated embodiment interacts with display assembly 130 to enable a user to input data by pointing and/or moving stylus 110 across a display of display assembly 130. For ease of illustration of the various components, it should be recognized that the components (e.g., stylus 110 and display assembly 130) are not drawn to scale in FIG. 1A. Display assembly 130 may comprise a central processing unit (CPU), memory, input/output, and instruction set (e.g., basic input/output system (BIOS), operating system, and/or application software) to provide a general purpose computing configuration. Stylus 110 comprises telemetry circuitry 111 to provide signals to input circuitry of display assembly 130 for determining a position of stylus 110.

However, and according to teachings of the present invention, stylus 110 has been adapted according to concepts described further herein to comprise rechargeable power supply 112, recharging circuitry 113, connector 114, and charge status indicator 115. Rechargeable power supply 112 may comprise any of a number of replenishable energy reservoirs, such as a lithium-ion battery, a nickel-cadmium battery, a gel-cell battery, a metal-hydride battery, etcetera. Recharging circuitry 113 of this embodiment provides recharging of rechargeable power supply 112 using energy provided to recharging circuitry 113 from an external source, provides monitoring of the charge/recharge state of rechargeable power supply 112, and provides overcharge control to prevent damage to rechargeable power supply 112 through excessive charging. Accordingly, recharging circuitry 113 may comprise voltage and/or current regulators, voltage and/or current detectors, voltage and/or current comparators, switching circuitry, and logic for analyzing and controlling voltage and/or current with respect to rechargeable power supply 112. Recharging circuitry 113 may further comprise circuitry to prevent depletion of rechargeable power supply 112 when coupled to display assembly 130 when power supply 131 is not providing charging energy. For example, recharging circuitry 113 may comprise diodes or other reverse current circuitry to prevent discharging rechargeable power supply 112 when display assembly 130 is powered-down. Connector 114 of the illustrated embodiment provides connectivity between recharging circuitry 113 and an external source of energy. Charge status indicator 115 of the illustrated embodiment is coupled to recharging circuitry 113 to output information with respect to a charge/recharge status of rechargeable power supply 112. Charge status indicator 115 may comprise any of a number of output technologies, such as light emitting diode (LED), liquid crystal display (LCD), audio speaker, piezo-electric crystal, etcetera.

Cable assembly 120 of the illustrated embodiment couples stylus 110 to display assembly 130. Embodiments of cable assembly 120 provide dual functionality by providing 1) a tether between stylus 110, and display assembly 130 and 2) a charging circuit link between stylus 110 and display assembly 130. Accordingly, connector 121 of cable assembly 120 interfaces with connector 114 of stylus 110 to both physically couple cable assembly 120 to stylus 110 and electrically couple cable assembly 120 to recharging circuitry 113. Similarly, connector 122 of cable assembly 120 interfaces with connector 132 of display assembly 130 to both physically couple cable assembly 120 to display assembly 130 and electrically couple cable assembly 120 to power supply 131 of display assembly 130. In some embodiments, when not in use to provide a tether between stylus 110 and display assembly 130 and/or charging of rechargeable power supply 112, cable assembly 120 may be separated from either or both of stylus 110 and display assembly 130. It will be appreciated that a user may use stylus 110 with or without being connected to cable assembly 120. However, if rechargeable power supply 112 of stylus 110 becomes depleted, cable assembly 120 may be utilized to provide power to continue use of stylus 110 and/or to provide a charge to rechargeable power supply 112. In operation according to embodiments of the invention, stylus 110 may be coupled to and decoupled from cable assembly 120 without disrupting operation of stylus 110.

Cable assembly 120 of certain embodiments comprises conductors to complete a charging circuit from power supply 131 to rechargeable power supply 112 via recharging circuitry 113. For example, cable assembly 120 may comprise two isolated conductors (shown as conductors 125 and 126 in the cut-away illustration of FIG. 1B) to provide a charge current loop between power supply 131 and rechargeable power supply 112.

Cable portion 123 of cable assembly 120 of certain embodiments is sufficiently flexible to enable a user substantially free movement of stylus 110 during manual manipulation, such as to provide a suitable user experience when drawing, writing, and otherwise moving stylus 110. However, conductors of cable assembly 120 should be of sufficient gauge to accommodate the flow of charging current without excessive resistance. It is expected that rechargeable power supply 112 will be relatively low voltage and capacity, by way of example and not a limitation, on the order of the power available from a commercially available AAAA sized alkaline battery. Accordingly, embodiments may utilize conductors of 32 gauge to provide a sufficiently flexible cable portion 123 without experiencing excessive resistance.

Cable assembly 120 of this example embodiment provides cable portion 123 of sufficient length to facilitate a user's substantially unimpeded manipulation of stylus 110 over all relevant portions of a display of display assembly 130. For example, in a typical tablet PC configuration, cable assembly 120, by way of example and not a limitation, provides cable portion 123 of at least 15 inches in length, thereby enabling a user to manipulate stylus 110 over the entire surface of a display sized to correspond to a legal-sized paper (8.5 inches by 14 inches) irrespective of where connector 132 is disposed on display assembly 130. Other embodiments may use different lengths for cable portion 123, such as where connector 132 is disposed in the center of a longest edge of display assembly 130, where a corresponding display is sized differently than above, etcetera.

Cable portion 123 of the illustrated embodiment is coiled to cause cable assembly 120 to retract to a smaller length when additional length is not needed for a user's current manipulation of stylus 110. As a user's current manipulation of stylus 110 moves stylus 110 about a display of display assembly 130, coils of cable portion 123 may extend and contract to provide a cable assembly of suitable length. Other embodiments may use a non-coiled (straight) cable portion or other configurations (e.g., combination of coiled and non-coiled), if desired.

Although connector 114 of various embodiments may be disposed most anywhere on stylus 110 (except perhaps a writing tip of stylus 110), the illustrated embodiment shows connector 114 disposed at an end of stylus 110 opposite a writing tip thereof. Accordingly, cable assembly 120 may be directed up and away from a user's hand and thus not substantially impact the user experience.

Embodiments of connectors 121 and 122 of cable assembly 120 provide sufficient resistance to detachment when interfaced with corresponding ones of connectors 114 and 132 to discourage unintended separation as stylus 110 is manipulated by a user. For example, the physical interface of connectors 114 and 121 and of connectors 122 and 132 may provide a friction fit, implement an interlocking detent and corresponding protrusion, etcetera to withstand tension experienced by cable assembly 120 during ordinary manipulation of stylus 110 by a user. Additionally or alternatively, connectors 114 and 121 and/or connectors 122 and 132 may be disposed such that their axis of interface is not aligned (e.g., perpendicular) with the expected axis of tension to be experienced by cable assembly 123 to further resist unintended separation. For example, because stylus 110 is expected to be held as a writing instrument in the user's hand, an axis of tension to be experienced by cable assembly 123 would be expected to be substantially perpendicular to the length of stylus 110. Accordingly, disposing connectors 114 and 121 to have an axis of interface (e.g., direction of mating insertion) coaxial with the length of stylus 110 may be relied upon to provide resistance to withstand tension experienced by cable assembly 120.

Where relatively high tension is expected to be experienced by cable assembly 120, and/or where the interface of the connectors does not otherwise provide suitable resistance to unintended separation, certain embodiments may implement latching or locking mechanisms to maintain an interface between connectors, shown as locking mechanism 124 in FIG. 1A. For example, a spring clip latching mechanism, a locking member mechanism, a bayonet connection, a threaded connection, or other apparatus may be utilized in maintaining an interface between connectors, such as connectors 114 and 121 and connectors 122 and 132.

Certain embodiments use standardized connector assemblies with respect to either or both of groups of connectors 114 and 121 and connectors 122 and 132. For example, one embodiment may utilizes a mini-universal serial bus (USB) connector assembly as connectors 114 and 121. In such an embodiment, a male mini-USB connector (USB plug) may be provided as connector 114 and a female mini-USB connector (USB receptacle) may be provided as connector 121. Of course, the male/female arrangement of connectors 114 and 121 may be reversed, if desired. However, the use of a female mini-USB connector as connector 121 of cable assembly 120 is desirable in many circumstances because convention suggests that certain types of power connectors be female at a potentially “live” power cable end. However, a female connector (e.g., USB receptacle) as connector 114 may be desired according to some embodiments to provide improved design aesthetics with respect to the stylus assembly. Although a male connector is employed in the illustrated embodiment, it will be appreciated that, due to the relatively low power provided by various embodiments for recharging the stylus power supply, there is little concern about the potentially “live” power cable.

One embodiment utilizes a USB-Type-A connector assembly as connectors 122 and 132. In such an embodiment, a female USB-Type-A connector (USB receptacle) may be provided as connector 132 and a male USB-Type-A connector (USB plug) may be provided as connector 122. Of course, the male/female arrangement of connectors 122 and 132 may be reversed, if desired. However, the use of a male USB-Type-A connector as connector 122 of cable assembly 120 is desirable in many circumstances as commercially available tablet PC configurations, corresponding to display assembly 130, often include a female USB-Type-A connector to facilitate coupling displays assembly 130 to a plurality of devices (e.g., printers, scanners, etcetera).

Several advantages to employing a mini-USB/USB-type A connector assembly in various embodiments of stylus include: the connectors are relatively small, the connectors' form factor is shaped to substantially conform to the shape of stylus 110, the connectors provide a friction interface which provides acceptable resistance to separation, and the connectors are adapted to supply power to components coupled thereto.

A variety of connector assemblies may be utilized according to various embodiments provide herein, such as Deutsches Insitut für Normung (DIN) connectors, mini-DIN connectors, MOLEX connectors, bayonet connectors, coaxial connectors (e.g., Subminiature Version A (SMA) connectors, Threaded Neill-Concelman (TNC) connectors, Subminiature Version B (SMB) connectors, and Type N (N) connectors), phone-jack connectors (e.g., 0.25″ tip-and-ring connector/socket), power adaptor connectors (e.g., CON-7/CON-8), or other connector capable of handling relatively low power and providing an acceptably compact design. However, the illustrated embodiment of FIG. 1A utilizes a USB connector as connector 122 to facilitate coupling of cable assembly 120, and thus stylus 110, to a commercially available tablet PC version of display assembly 130 without any adaptation or alternation to the commercially available tablet PC. In such an embodiment, recharging circuitry 113 is adapted to accept the voltage and current levels available from an industry standard USB output for recharging rechargeable power supply 112.

Recharging circuitry 113 of the illustrated embodiment is further adapted to provide signals to charge status indicator 115 indicative of a status of rechargeable power supply 112. For example, recharging circuitry 113 may provide signals indicating that rechargeable power supply 112 is being recharged and that rechargeable power supply has been fully recharged. Additionally or alternatively, recharging circuitry 113 may provide signals indicating a level of energy stored by rechargeable power supply 112. Accordingly, charge status indicator 115 may comprise any of a number of technologies to display the foregoing information to a user. For example, charge status indicator 115 may comprise a multi-color LED (e.g., red/green) to light a first color (e.g., red) when rechargeable power supply 112 is being recharged by recharging circuitry 113, to light a second color (e.g., green) when rechargeable power supply 112 is fully charged, and to remain unlit (or light a third color) when stylus 110 is not coupled to an external power supply. Additionally or alternatively, charge status indicator 115 may comprise a group of LEDs which serially light to show charge status/energy level. In addition to or in the alternative to the above-mentioned LEDs, embodiments of the stylus may use other types of visual displays, such as an LCD display showing a graphical battery level, icons for charging, text and/or numbers to convey information, etcetera. Likewise, audio output, such as through the use of an audio speaker or piezo-electric crystal, may be provided by charge status indicator 115, if desired.

Although embodiments have been described above with respect to charge status indicator 115 receiving signals from recharging circuitry 113 indicating a status of rechargeable power supply 112, charge status indicator 115 may receive such signals from and/or autonomously query other components of stylus 110 for such information. For example, charge status indicator 115 may be directly coupled to rechargeable power supply 112 to determine a status thereof.

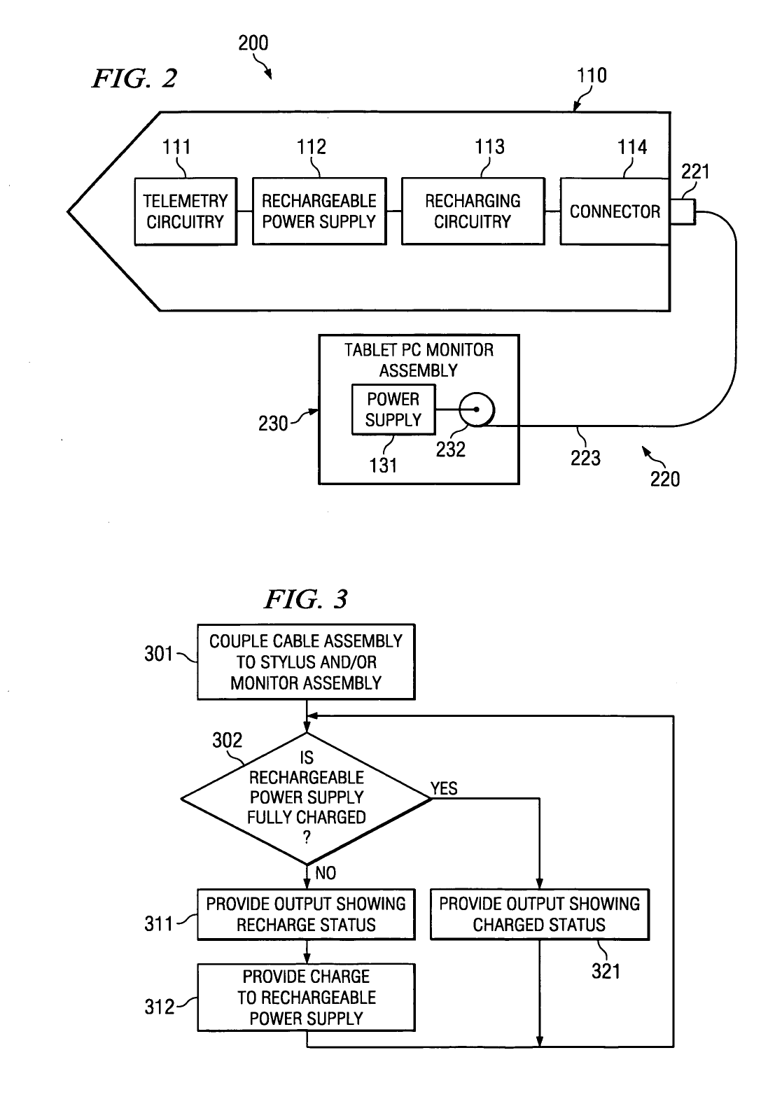

Directing attention to FIG. 2, tablet PC system 200 adapted according to one embodiment is shown. Stylus 110, as described above with reference to FIG. 1A, interacts with display assembly 230 to enable a user to input data by pointing and/or moving stylus 110 across a display of display assembly 230. Display assembly 230 of FIG. 2 is configured similarly to display assembly 130 of FIG. 1A and may comprise a central processing unit (CPU), memory, input/output, and instruction set (e.g., basic input/output system (BIOS), operating system, and/or application software) to provide a general purpose computing configuration as is well-known in the tablet PC art. However, as discussed in more detail below, display assembly 230, and corresponding cable assembly 220, of FIG. 2, can comprise several variations with respect to the embodiment illustrated in FIG. 1A. Additionally, stylus 110 of FIG. 2 has change status indicator 115 omitted to illustrate another embodiment of a stylus according to concepts of the present invention.

Cable interface 232 of the illustrated embodiment of display assembly 230 provides connectivity between power supply 131 and cable assembly 220 without the use of a connector assembly. Instead, cable portion 223 of cable assembly 220 is substantially permanently attached to display assembly 230 (i.e., permanent and substantially permanent as used herein means that cable assembly 220 is not removable from display assembly 230 without the aid of tools). Additionally, cable interface 232 of the illustrated embodiment is adapted to provide storage of cable assembly 220. For example, cable interface 232 may comprise a spring-driven spool to retract cable portion 223 into display assembly 230 when stylus 210 is not in use. Such a retractable cable storage mechanism may comprise a latching mechanism to enable cable portion 223 to be extended to a desired length and the retractable cable storage mechanism locked until cable portion 223 is to be retracted or further extended. Such a locking mechanism may be implemented by a “tug-and-release” motion similar to that of spring-driven window shade mechanisms. Additionally or alternatively, display assembly 230 may comprise a cavity for accepting cable assembly 220 and/or stylus 210, with or without the above-mentioned retractable cable storage mechanism.

As with cable assembly 120 of FIG. 1A, cable assembly 220 of the embodiment of FIG. 2 couples stylus 110 to display assembly 230. Connector 221 may be configured as described above with respect to connector 121. Embodiments of cable assembly 220 provide dual functionality by providing 1) a tether between stylus 110 and display assembly 230 and 2) a charging circuit link between stylus 110 and display assembly 230. Accordingly, connector 221 of cable assembly 220 interfaces with connector 114 of stylus 110 to both physically couple cable assembly 220 to stylus 110 and electrically couple cable assembly 220 to recharging circuitry 113. As discussed above, cable interface 232 of the illustrated embodiment provides connectivity between power supply 131 and cable assembly 220. In some embodiments, when not in use to provide a tether between stylus 110 and display assembly 230 and/or charging of rechargeable power supply 112, cable assembly 220 may be separated from stylus 110 and stored within display assembly 230.

Certain embodiments of cable assembly 220 comprise conductors to complete a charging circuit from power supply 131 to rechargeable power supply 112 via recharging circuitry 113, as described above with respect to cable assembly 120. Likewise, cable portion 223 of cable assembly 220 of embodiments is flexible as described above with respect to cable portion 123, and therefore may utilize similar gauge conductors. Cable assembly 220 of contain embodiments, like cable assembly 120 discussed above, provides cable portion 223 of sufficient length to facilitate a user's substantially unimpeded manipulation of stylus 110 over all relevant portions of a display of display assembly 230.

Cable portion 223 of the illustrated embodiment is non-coiled to facilitate use of a retractable cable storage mechanism as part of cable interface 232 as described above. Certain embodiments may use a coiled cable portion or other configurations (e.g., combination of coiled and non-coiled), if desired.

From the above, it can be appreciated that the embodiment illustrated in FIG. 1A provides a configuration in which display assembly 130 need not be specifically adapted to implement concepts disclosed herein. Specifically, display assembly 130 may be retrofitted to use stylus 110 of an embodiment of the invention without modifying display assembly 130. The embodiment illustrated in FIG. 2, however, comprises specific adaptation of display assembly 230 in implementing certain concepts of this disclosure. Of course, features and functions of the embodiment of FIG. 2 may be implemented without specifically adapting a corresponding display assembly. For example, a substantially permanent interface may be provided at the stylus end of a cable assembly (or both ends of a cable assembly), if desired. Additionally or alternatively, cable storage, such as in the form of a retractable cable storage mechanism, may be provided within a stylus assembly according to certain embodiments.

FIG. 3 shows a flow diagram of operation of circuitry of stylus 110 for recharging according to embodiments of the invention, such as those illustrated in FIGS. 1 and 2. At block 301, a cable assembly of an embodiment (e.g., cable assembly 120 or 220) is coupled to a stylus having a rechargeable power supply (e.g., stylus 110) and/or to a corresponding display assembly (e.g., display assembly 130). Coupling of the cable assembly to a stylus and/or display assembly as in block 301 may be accomplished for a number of reasons. For example, the rechargeable power supply of the stylus may have been exhausted, thus preventing further user input using the stylus. Additionally or alternatively, a low rechargeable power supply indicator (e.g., audible tone, light, or display) may have been provided by charge status indicator 115 thereby signaling to a user that continued operation of the stylus may not be possible. A user may desire that the stylus be physically coupled to the display assembly to prevent the stylus from being misplaced. Accordingly, a user may couple the cable assembly to either or both of the stylus and display assembly at any time desired and the stylus will continue to normally operate.

At block 302 a determination is made as to whether the rechargeable power supply of the stylus is fully charged. For example, logic of recharging circuitry may determine from a voltage level and/or an input current level that rechargeable power supply 112 is fully charged or should be recharged.

If, at decision block 302, it is determined that the rechargeable power supply is not fully charged, processing according to the illustrated embodiment proceeds to block 311. At block 311 output is provided to show that the rechargeable power supply of the stylus is being recharged. For example, recharging circuitry 113 may provide an appropriate signal to charge status indicator 115 to cause charge status indicator 115 to illuminate a LED (e.g., red) indicating “charging.” At block 312, charging current and/or voltage is provided to the rechargeable power supply. For example, recharging circuitry 113 controls a current loop provided from power supply 131 through the cable assembly (e.g., cable assembly 120 or 220) to rechargeable power supply 112. Thereafter, processing according to the illustrated embodiment returns to block 302 for a determination as to whether the rechargeable power supply has been fully charged or not.

If, at decision block 302, it is determined that the rechargeable power supply is fully charged, processing according to the illustrated embodiment proceeds to block 321. At block 321 output is provided to show that the rechargeable power supply of the stylus is fully charged. For example, recharging circuitry 113 may provide an appropriate signal to charge status indicator 115 to cause charge status indicator 115 to illuminate a LED (e.g., green) indicating “charged.” Thereafter, processing according to the illustrated embodiment returns to block 302 for a determination as to whether the rechargeable power supply has been discharged.

At any point in the flow diagram of FIG. 3, a user may separate the cable assembly from either or both of the stylus and display assembly. The stylus will continue to operate normally during both separation and connection operations, provided sufficient energy is present in the rechargeable power supply. Accordingly, a user may use a stylus to the point that the rechargeable power supply is exhausted and then couple a cable assembly of an embodiment between the stylus and display to continue use of the stylus and corresponding display assembly. A tablet PC implementing an embodiment will therefore not be unusable merely because a stylus power supply has been depleted.

Although an embodiment has been described above providing recharging to stylus 110 when coupled to display assembly 130 and rechargeable power supply 112 is not fully charged, embodiments may apply further decision-making in a charge control circuit, if desired. For example, a determination may be made not to charge rechargeable power supply 112 when a power supply of display assembly 130 is too low. Battery chemistry may suggest that rechargeable power supply 112 should not be recharged until fully depleted. Accordingly, intelligence may be implemented to manage charging rechargeable power supply 112 without damaging the rechargeable power supply.

Embodiments disclosed herein may utilize the foregoing cable assembly to provide charging of devices in addition to or in the alternative to a stylus as discussed with respect to example embodiments described herein. For example, where a standardized connector is used to interface with the stylus, this same connector on the cable assembly may instead be coupled to another device (assuming it is fitted with a recharging circuit), such as a cell phone, a personal digital assistant (PDA), a wireless personal communication terminal (e.g., the BLACKBERRY wireless personal communication terminal available from Research in Motion), etcetera. Because the opposing end of embodiments of cable assembly have a corresponding standardized connector, the cable assembly may be used in recharging such other coupled device from another device possessing a source of power, e.g., a battery, power cord, etcetera. Likewise, the concepts of the present invention are not limited to such as PDAs, cell phones, pages, game systems, etcetera. As one example a BLUETOOTH peripheral, such as the BLUETOOTH peripheral becomes discharged during use, to avoid interruption of a cellular phone call. It will also be appreciated that embodiments can power the stylus from another device other than a tablet computer. It will be further appreciated that embodiments enable the stylus to operate with devices other than a tablet computer, powering the stylus as desired.

What is claimed is:

1. A system comprising:
a cable assembly having a connector for coupling to at least one of a stylus and a display assembly, said cable assembly having at least one conductor for providing charging power to a rechargeable power supply of said stylus from a power supply of said display assembly.

2. The system of claim 1 wherein said cable assembly comprises a coiled cable portion.

3. The system of claim 1 wherein said cable assembly comprises a cable portion adapted to interface with a retractable cable storage mechanism.

4. The system of claim 1 wherein said cable assembly comprises a cable portion having a length to enable manipulation of said stylus over all relevant portions of a display of said display assembly.

5. The system of claim 1 wherein said connector provides sufficient resistance to detachment from a corresponding connector when coupled thereto to prevent unintended separation during normal use of said stylus.

6. The system of claim 1 wherein said connector comprises a locking mechanism to prevent unintended separation of said stylus from said display assembly.

7. The system of claim 1 wherein said cable assembly further has a second connector for coupling to at least one of a stylus and a display assembly, wherein said connector couples said cable assembly to one of said stylus and display assembly and said second connector couples said cable assembly to the other one of said stylus and display assembly.

8. The system of claim 7 wherein said connector comprises a mini-USB connector and said second connector comprises a USB-Type-A connector.

9. The system of claim 1 wherein said connector comprises an industry standard connector configuration.

10. A system comprising:
a stylus having a rechargeable power supply; and
a cable assembly having a connector for coupling to at least one of said stylus and a display assembly, said cable assembly completing a charging circuit between said rechargeable power supply and a power supply of said display assembly when coupled to said stylus and said display assembly.

11. The system of claim 10 wherein said display assembly comprises a tablet computer.

12. The system of claim 10 wherein said cable assembly is substantially permanently coupled to said display assembly.

13. The system of claim 10 wherein said display assembly comprises a retractable cable storage mechanism coupled to said cable assembly and operable to store at least a portion of said cable assembly.

14. The system of claim 10 wherein said display assembly comprises an industry standard interface for coupling said display assembly to a plurality of devices, and wherein said connector is selected to interface with said industry standard interface.

15. The system of claim 10 wherein said stylus further has a charge status indicator.

16. The system of claim 15 wherein said charge status indicator is coupled to at least one of said rechargeable power supply and said recharging circuit to provide output of a charge status of said rechargeable power supply.

17. The system of claim 15 wherein said charge status indicator comprises a light emitting diode.

18. The system of claim 15 wherein said charge status indicator comprises a liquid crystal display.

19. The system of claim 15 wherein said charge status indicator comprises an audio output device.

20. The system of claim 10 wherein said stylus further has a connector to interface with said connector of said cable assembly, wherein said connector of said stylus is disposed such that an axis of interface with respect to said connectors is not aligned with an expected axis of tension expected to be experienced by said cable assembly.

21. The system of claim 10 wherein said stylus comprises a recharging circuit.

22. The system of claim 21 wherein said recharging circuit comprises reverse current circuitry to prevent discharging the rechargeable power supply through the display assembly.

23. A method comprising:
coupling a cable assembly between a stylus and a corresponding display assembly; and
providing charging power from said display assembly to said stylus to recharge a rechargeable power supply of said stylus.

24. The method of claim 23 wherein said coupling comprises:
coupling a connector of said cable assembly to an interface of said display assembly provided for coupling said display assembly to a plurality of devices.

25. The method of claim 23 wherein said coupling comprises:
withdrawing at least a portion of said cable assembly from a retractable cable storage mechanism.

26. The method of claim 23 wherein said coupling comprises:
engaging a locking mechanism of a connector.

27. The method of claim 23 further comprising:
providing output showing a status of said providing charging power.

28. The method of claim 23 further comprising:
determining if said rechargeable power supply is fully charged.

29. A system comprising:
means for electrically coupling a stylus to a corresponding display assembly; and
means for charging a rechargeable power supply of said stylus using power from said display assembly.

30. The system of claim 29 wherein said means for electrically coupling comprises:
means coupling said display assembly to each of a plurality of devices.

31. The system of claim 29 further comprising:
means for retracting at least a portion of a cable assembly of said means for electrically coupling into a cable storage mechanism.

32. The system of claim 29 further comprising:
means for providing output showing a status of said charging said rechargeable power supply.
